(19) United States
(12) Patent Application Publication
(10) Pub. No.: US 2025/0343696 A1
(43) Pub. Date: Nov. 6, 2025

(54) Access Control for a Motor Vehicle

(71) Applicant: Bayerische Motoren Werke Aktiengesellschaft, Muenchen (DE)

(72) Inventor: Marco HIPPLER, Muenchen (DE)

(21) Appl. No.: 19/192,882

(22) Filed: Apr. 29, 2025

(30) Foreign Application Priority Data
May 6, 2024 (DE) 10 2024 112 709.0

(51) Int. Cl. H04L 9/32; G07C 9/00

(52) U.S. Cl. CPC H04L 9/3226; G07C 9/00309; H04L 9/3242

(57) ABSTRACT

A method for creating a new digital vehicle key for a motor vehicle includes independently determining an identification of a key request for the new digital vehicle key on the part of an owner device and on the part of a friend device. The identification is determined in each case by a cryptographic hash function with respect to the key request. It is proposed to determine the hash function additionally with respect to the nonce selected by the owner device and to transmit the nonce separately from the key request to the friend device. The identifications are transmitted to a key management, which provides the new vehicle key if the identifications match each other.

### CROSS REFERENCE TO RELATED APPLICATION

This application claims priority under 35 U.S.C. § 119 from German Patent Application No. 10 2024 112 709.0, filed May 6, 2024, the entire disclosure of which is herein expressly incorporated by reference.

### BACKGROUND AND SUMMARY

The present invention relates to access control for a motor vehicle. In particular, the invention relates to access control by means of a digital vehicle key.

Access to a motor vehicle can be secured by means of a digital key. The digital key can be stored on a device. The device and the motor vehicle can authenticate each other, and if the authentication is successful, a requested predetermined function of the motor vehicle can be controlled. More specifically, mutual authentication can preferably be based on an asymmetric cryptographic encryption method, in which the device and the motor vehicle are each associated a pair of a private and a public cryptographic key. The digital vehicle key follows the specifications of the Car Connectivity Consortium (CCC).

The owner can pass on an authorization to use the motor vehicle to a friend. To create a new digital vehicle key for the friend a known method can be carried out, which provides for a key management to provide the new vehicle key based on a key request if a first identification of the key request, which was transmitted from an owner device, and a second identification of the key request, which was transmitted from a friend device, match. The identifications are determined by means of a predetermined cryptographic hash function.

A new vehicle key can be assigned the authorization to issue another new vehicle key. Key requests of interlinked vehicle keys can match in their key requests, so that the possibility of a collision of key requests on the part of the key management exists.

A task underlying the present invention consists in providing an improved technology for avoiding such a collision. The invention solves this task by means of the objects of the independent claims. The dependent claims indicate preferred embodiments.

A method for creating a new digital vehicle key for a motor vehicle comprises, on the part of an owner device, steps for determining a key request for the digital vehicle key; for determining a nonce; for transmitting the key request and the nonce to a friend device; for determining a first identification of the key request by using a predetermined cryptographic hash function to the key request and the nonce; and for transmitting the first identification to a key management. The method comprises, on the part of the friend device, steps for determining a second identification of the key request by using the predetermined cryptographic hash function to the key request and the nonce; and for transmitting the second identification to the key management. The method comprises, on the part of the key management, steps for determining that the first and the second identification match; and for providing the new vehicle key.

A person who has a predetermined authorization regarding the motor vehicle is referred to herein as the owner. The owner acts by means of a device, usually a mobile device, on which a cryptographic key, which identifies the owner, is stored. For the use of the key, the owner can authenticate themselves to the device, for example, by presenting a biometric feature or by entering a predetermined secret. Optionally, the owner can also be a non-human person. In this case, it is preferred that the device comprises a server, a service, or a similar automatic device.

The new key is to be provided to a person who is referred to herein as a friend. Correspondingly, the friend acts by means of a friend device. Here too, a non-human person and the use of a device other than a mobile device is possible.

The key management is realized as a central service, for example, in a cloud or on a server. Usually, this service is operated by a manufacturer of the motor vehicle. As described in the above-mentioned Technical Specification, further servers or services can be involved in the management of digital vehicle key. It is noted that some of the processes of the creation of the key are simplified or presented without indicating details. The person skilled in the art adds further information from the applicable specification as a matter of course.

The proposed method is based on a method for creating a new digital vehicle key, which is described in the Technical Specification of the Digital Vehicle Key of the CCC. It is proposed to extend the known method in that the cryptographic hash method on the part of the owner device works not only on the key request, but additionally on a nonce. In other words, it is proposed that the hash should include a random value (“salt”), so that a “salted hash” is created. By transmitting the nonce to the friend device, the latter can determine the second identification after receiving the key request. The nonce can also be included as a new field in the key request.

The owner device can deposit the key request to a deposit service in a mailbox to the friend device; and the friend device can download the key request from the mailbox. In this case, the key request can be securely transmitted to the friend device without the identification.

The key management can transmit the new vehicle key to the friend device; and transmit an attestation of the new vehicle key to the motor vehicle. The new vehicle key can thus be used for controlling a function of the motor vehicle.

In one embodiment, a secure channel is used to transmit data from the owner device to the friend device. In another embodiment, the owner device uses a “device PIN” method. The owner device creates a PIN; and transmits the PIN to a key management and the friend device. The friend device transmits the received PIN together with the second identification to the key management; and the key management determines that the PIN received from the owner device matches with the PIN received from the friend device, before it provides the new digital vehicle key. The PIN can comprise a preferably multi-digit number or generally any string of digits. A user of the friend device usually has to read the received PIN and re-enter it into the friend device to enable further processing.

The PIN can be transmitted in on a different transmission channel than the key request from the owner device to the friend device. Furthermore, the PIN can be transmitted in a different communication channel than the address of the deposit service.

The nonce can also be transmitted in a different transmission channel than the PIN from the owner device to the friend device. The nonce is possibly transmitted in the same channel as the address of the mailbox.

The nonce can be transmitted in a different transmission channel than the key request from the owner device to the friend device. The nonce is possibly transmitted on the same channel as the PIN. In general, different transmission channels can use different physical media for the transmission, at least on one part of the transmission path.

The nonce can generally comprise a random or pseudo-random character string. For example, the owner device can generate a random number or a random character string itself or obtain it from an external source. The nonce can be determined based on a current time, for example. Due to the use of the cryptographic hash function, two identifications, which were created with regard to the same key request and similar but different nonces, are no longer similar. A conclusion from an identification to a key request can certainly be prevented.

The predetermined cryptographic hash method can be comprised by the secure hash algorithm 2 (SHA-2) group. In a preferred embodiment, SHA-256 is used as the hash method. Another hash method is also possible but does not conform to the applicable Technical Specification of the Digital Vehicle Key.

A first mobile device, which herein is also called owner device, is configured for determining a key request for a new digital vehicle key; for transmitting a nonce; for determining the key request and transmitting the nonce to a friend device; for determining a first identification of the key request by using a predetermined cryptographic hash function to the key request and the nonce; and for transmitting the first identification to a key management. For this purpose, the first mobile device preferably comprises a processing device and at least one communication device, preferably a wireless communication device.

A second mobile device, which herein is also called friend device, is configured for receiving a key request and a nonce from a first mobile device; for determining a second identification of the key request by using the predetermined cryptographic hash function to the key request and the nonce; and for transmitting the second identification to a key management. For this purpose, the second mobile device preferably comprises a processing device and at least one communication device, preferably a wireless communication device. To use the “device pin” method, an interaction device for a user should also be included.

Furthermore, both mobile devices preferably each comprise a secure memory, which can preferably only be accessed if an associated user has authenticated themselves to the device, for example by presenting a biometric feature or by entering a predetermined secret.

A key management is configured for receiving a first identification of a key request for a new key for a motor vehicle from an owner device; for receiving a second identification of a key request for a new key for the motor vehicle from a friend device; for determining that the first and the second identification match; and for providing the new vehicle key.

Key management is usually implemented as a central service or server.

Typically, the key management is configured for managing digital vehicle keys for a plurality of digital motor vehicles. In particular, a digital signature of the key management system may be required for providing a functioning digital vehicle key based on a key request.

The invention will now be described with reference to the accompanying figures, in which

### BRIEF DESCRIPTION OF THE DRAWINGS

FIG. 1 shows a system; and

FIG. 2 shows a flowchart of a method.

### DETAILED DESCRIPTION OF THE DRAWINGS

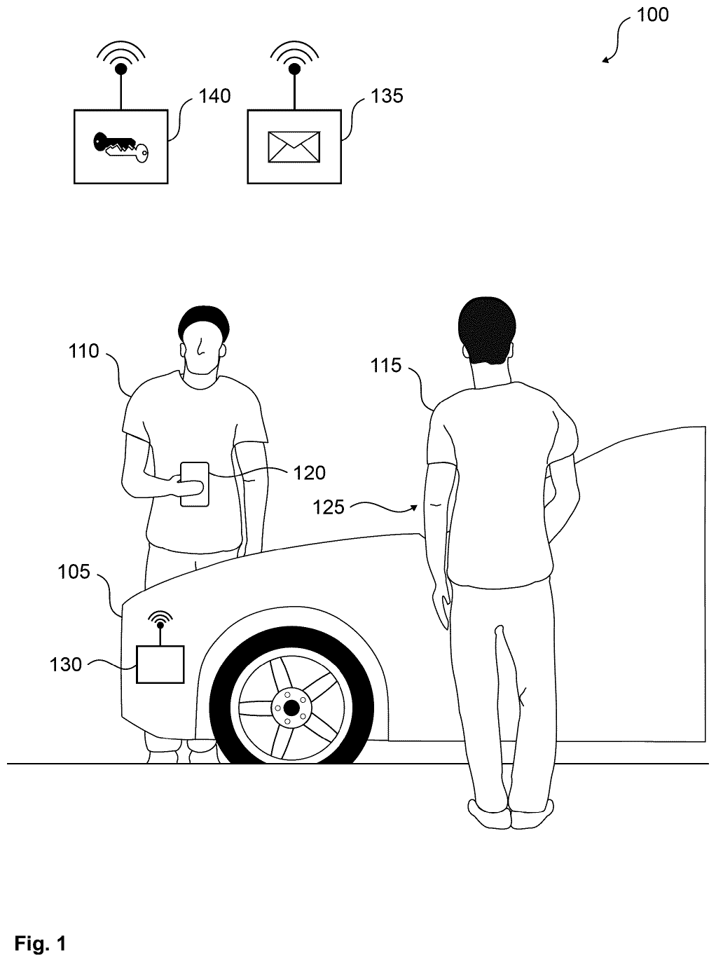

FIG. 1 shows a system 100 for managing digital vehicle keys for a motor vehicle 105. The system is based on a technology described as a digital vehicle key by the CCC. The system presented 100 does not comprise all possible or necessary components, but only those that contribute to the understanding of the present invention.

A first person 110 is referred to herein as the owner; this person has the power of disposal for the motor vehicle 105. A second person 115 is referred to herein as a friend; a new digital vehicle key is to be issued for this person. The designations are to be understood as non-restrictive and follow the designations (“owner” and “friend”) of the aforementioned Technical Specification. The owner 110 acts with respect to cryptographic operations and the sending or receiving of information by an owner device 120. Similarly, the friend 115 acts by a friend device 125 (not visible).

Actions of the motor vehicle 105 as described herein may be performed by a control device 130, which may control a predetermined security function of the motor vehicle 105, such as opening a central locking system, following successful mutual identification with a device 120, 125, based on a digital vehicle key via a wireless connection. The control device 130 may also communicate with another external service or server, preferably via a wireless connection.

A deposit service 135 is configured for receiving a key request from an owner device 120 and for storing it in a mailbox. The mailbox is usually generated as part of the deposit process and provided with a unique address, which is transmitted back to the owner device 120. Based on the address, the friend device 125 can pick up the key request from the deposit service 135. The mailbox can be removed again after the key request has been successfully downloaded.

A key management system 140 is configured as a central instance for checking a key request and, if the check is successful, for providing a digital vehicle key based on the key request. In particular, the vehicle key can be transmitted to an associated friend device 125. In addition, an attestation package can be provided and transmitted to the motor vehicle 105. Only then can the motor vehicle 105 accept a digital vehicle key presented or used by the friend device 125.

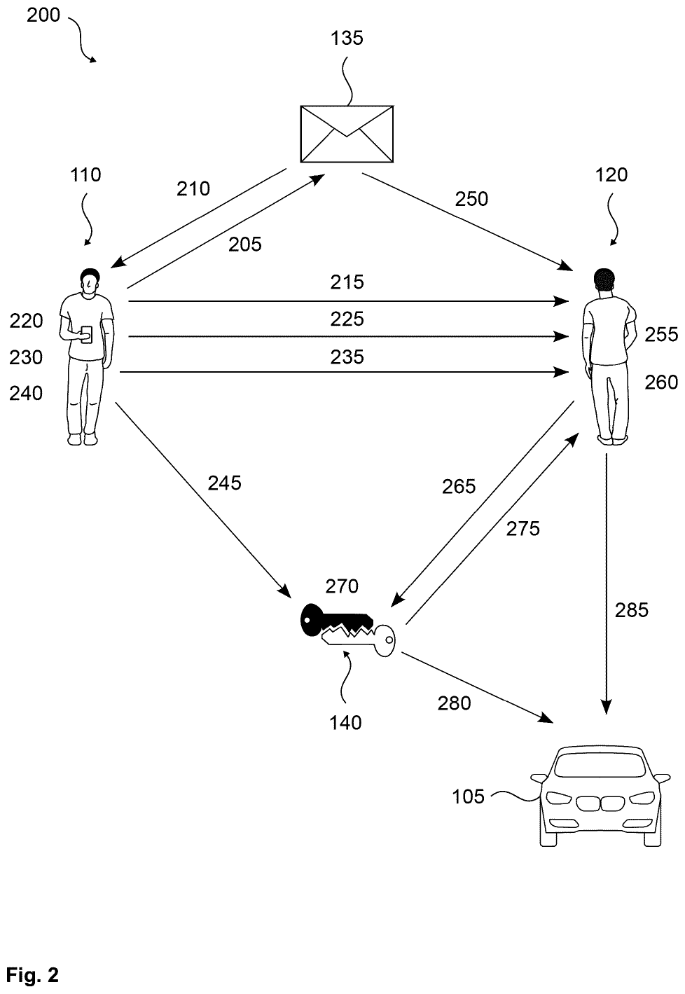

FIG. 2 shows a flowchart for a method 200 for generating a new digital vehicle key on the system 100 of FIG. 1.

The method shown is simplified and is essentially limited to aspects that are relevant to the technology presented.

In a step 205, the owner device 110 generates a key request and deposits it with the deposit service 135 in a mailbox. The deposit service 135 responds in a step 210 with a unique address of the mailbox. The owner device 110 transmits the address to the friend device on a first channel in a step 215.

In a step 220, the owner device 110 determines a PIN, which is referred to herein as O_PIN (owner pin). The O_PIN is transmitted to the friend device 125 on a second channel in a step 225.

In a step 230, the owner device 120 determines a nonce and transmits it to the friend device 125 in a step 235. The nonce can be transmitted alone; the first channel, the second channel or a third channel can be used for this purpose. The nonce can also be transmitted together with the address of the mailbox in step 215 on the first channel or together with the O_PIN in step 225 on the second channel.

In one step 240, the owner device 110 determines a first identification based on the key request and the nonce by means of a predetermined cryptographic hash function. In one step 245, the O_PIN and the first identification are transmitted to the key management system 140.

The friend device can download the key request in one step 250 from the mailbox at the deposit service 135, based on the address received in step 215. A second identification can then be determined in one step 255, based on the key request and the nonce received in step 235, for example, using the same predetermined hash function. The received O_PIN can be displayed to a user of the friend device (the friend 115) and a user input can be captured as F_PIN in a step 260. If the input is error-free, F_PIN is identical to O_PIN. If it turns out in the further course of the method that this is not the case, a mechanism can be provided to repeat part of the method 200. Typically, only a predetermined maximum number of repetitions is provided.

The F_PIN and the second identification can be transmitted to the key management system 140 in one step 265. In one embodiment, both pieces of information must be transmitted together in one message.

Key management system 140 now has both PINs and both identifications. In one step 270, the PINs and the identifications can be compared with one another in pairs. If it is determined that O_PIN=F_PIN and the first identification corresponds to the second identification, the new digital vehicle key can be created based upon the key request. For this purpose, the key management system 140 can sign the key request using its own private key. In one step 275, the generated key can be made available to the friend device 125.

In addition, a cryptographic attestation package can be determined and transmitted in one step 280 to the motor vehicle 105. In one embodiment, this is done directly; in another embodiment, the attestation package may be brought to the motor vehicle by means of the friend device 125. In one step 285, the friend device can control a predefined function of the motor vehicle 105 based on the generated digital vehicle key. For this purpose, the friend device 125 must typically be located in the area of the motor vehicle 105. Communication is carried out via a wireless interface.

### REFERENCE SIGNS

100 System
105 Motor vehicle
110 First person, owner
115 Second person, friend
120 Owner device
125 Friend device
130 Control device
135 Deposit service
140 Key management
200 Method
205 Depositing key request
210 Receiving mailbox address
215 Transmitting mailbox address to a friend device
220 Determining O_PIN
225 Transmitting O_PIN to friend device
230 Determining nonce
235 Transmitting nonce to friend device
240 Determining first identification
245 Transmitting first identification to key management
250 Downloading key request
255 Determining second identification
260 Determining F_PIN
265 Transmitting second identification and F_PIN to key management
270 Comparing identifications and PINs
275 Creating and providing key
280 Attestation package
285 Controlling function

What is claimed is:

1. A method for creating a new digital vehicle key for a motor vehicle, the method comprising:
determining, by an owner device, a key request for the digital vehicle key;
determining, by the owner device, a nonce;
transmitting, by the owner device, the key request and the nonce to a friend device;
determining, by the owner device, a first identification of the key request by using a predetermined cryptographic hash function to the key request and the nonce;
transmitting, by the owner device, the first identification to a key management;
determining, by the friend device, a second identification of the key request by using the predetermined cryptographic hash function to the key request and the nonce;
transmitting, by the friend device, the second identification to the key management;
determining, by the key management, that the first and the second identification match; and
providing, by the key management, the new digital vehicle key.

2. The method according to claim 1, wherein the owner device deposits the key request to a deposit service in a mailbox and transmits an address of the mailbox to the friend device, and the friend device downloads the key request from the mailbox.

3. The method according to claim 1, wherein the key management transmits the new digital vehicle key to the friend device and transmits a new attestation of the new digital vehicle key to the motor vehicle.

4. The method according to claim 2, wherein the key management transmits the new digital vehicle key to the friend device and transmits a new attestation of the new digital vehicle key to the motor vehicle.

5. The method according to claim 1, wherein the owner device creates a PIN, transmits the PIN to the key management and the friend device;
wherein the friend device transmits the PIN together with the second identification to the key management; and
wherein the key management determines that the PIN received from the owner device matches the PIN received from the friend device.

6. The method according to claim 2, wherein the owner device creates a PIN, transmits the PIN to the key management and the friend device;
wherein the friend device transmits the PIN together with the second identification to the key management; and
wherein the key management determines that the PIN received from the owner device matches the PIN received from the friend device.

7. The method according to claim 3, wherein the owner device creates a PIN, transmits the PIN to the key management and the friend device;
wherein the friend device transmits the PIN together with the second identification to the key management; and
wherein the key management determines that the PIN received from the owner device matches the PIN received from the friend device.

8. The method according to claim 5, wherein the PIN is transmitted on a different transmission channel than the key request from the owner device to the friend device.

9. The method according to claim 6, wherein the PIN is transmitted on a different transmission channel than the key request from the owner device to the friend device.

10. The method according to claim 7, wherein the PIN is transmitted on a different transmission channel than the key request from the owner device to the friend device.

11. The method according to claim 5, wherein the nonce is transmitted from the owner device to the friend device on a different transmission channel than the PIN.

12. The method according to claim 8, wherein the nonce is transmitted from the owner device to the friend device on a different transmission channel than the PIN.

13. The method according to claim 1, wherein the nonce is transmitted from the owner device to the friend device on a different transmission channel than the key request.

14. The method according to claim 2, wherein the nonce is transmitted from the owner device to the friend device on a different transmission channel than the key request.

15. The method according to claim 1, wherein the nonce comprises a random or pseudo-random character string.

16. The method according to claim 2, wherein the nonce comprises a random or pseudo-random character string.

17. The method according to claim 1, wherein the predetermined cryptographic hash function is comprised by an SHA-2 group.

18. A first mobile device configured to:
determine a key request for a new digital vehicle key;
determine a nonce;
transmit the key request and the nonce to a friend device;
determine a first identification of the key request by using a predetermined cryptographic hash function to the key request and the nonce; and
transmit a first identification to a key management.

19. A second mobile device configured to:
receive a key request and a nonce from a first mobile device;
determine a second identification of the key request by using the predetermined cryptographic hash function to the key request and the nonce; and
transmit the second identification to a key management.

20. A key management configured to:
receive a first identification of a key request for a new digital vehicle key for a motor vehicle from an owner device;
receive a second identification of the key request for the new digital vehicle key for the motor vehicle from a friend device;
determine that the first identification and the second identification match; and
provide the new digital vehicle key.
